(19) United States
(12) Patent Application Publication
(10) Pub. No.: US 2026/0195614 A1
(43) Pub. Date: Jul. 9, 2026

(54) SYSTEMS AND METHODS FOR ENHANCED MACHINE LEARNING TECHNIQUES FOR KNOWLEDGE MAP GENERATION AND USER INTERFACE PRESENTATION

(71) Applicant: Unified Intelligence, Inc., Westlake, OH (US)

(72) Inventor: Gang Tian, Westlake, OH (US)

(21) Appl. No.: 19/128,747

(22) PCT Filed: Nov. 9, 2023
(86) PCT No.: PCT/US2023/037105

§ 371 Date: May 9, 2025

Related U.S. Application Data
(60) Provisional application No. 63/424,134, filed on Nov. 10, 2022.

(51) Int. Cl. G06N 5/025; G06F 40/20; G06N 20/00

(52) U.S. Cl. CPC G06N 5/025; G06F 40/20; G06N 20/00

(57) ABSTRACT

Systems and methods for extracting information from documents and constructing corresponding knowledge maps with respect to defined knowledge models. Deep-learning based models for Natural Language Processing (NLP) are applied to tokenize words, tag, parse, and lemmatize sentences of input documents. Then an information extractor traverses the dependency tree of NLP object to recursively extract the entities of interest to the knowledge models. Finally, a knowledge map constructor traverses the dependency tree of NLP object to determine the relationships among the extracted entities and construct knowledge maps recursively following the defined knowledge models.

### CROSS-REFERENCE TO RELATED APPLICATION

This application claims priority to U.S. Prov. Patent App. No. 63/424,134 titled “SYSTEM AND METHOD OF INFORMATION EXTRACTION AND KNOWLEDGE MAP CONSTRUCTION” and filed on Nov. 10, 2022, the disclosure of which is hereby incorporated herein by reference in its entirety.

### BACKGROUND

### Technical Field

The present disclosure relates to machine learning models, and more particularly, to machine learning models for knowledge extraction.

### Description of Related Art

Manufacturing is the process of turning raw materials or parts into finished goods using tools, human labor, machinery, and chemical processing. For a finished product, its manufacturing process depends on the materials as well as the applied technologies and the configured machines. Process flow charts, operation procedures, and device configuration diagrams are created to capture the information of a manufacturing process. A manufacturing process flow chart is a set of separate steps in sequential order. The function of each step is to convert the input materials into the output materials physically or chemically. Each step can be completed in a single device or in a setup of multiple connected devices. Operators follow Standard Operating Procedures (SOP) to control devices, complete process steps and turn the input materials into intermediate materials, and eventually into final products. Operation procedures typically include all the details of the process, including the input material specifications, device configurations, and a serial of interactions between the operators and the devices.

Manufacturing Process Management (MPM) is a sophisticated task, involving design, simulation, resource planning, quality assurance, operation management, and so on. Various software/solutions are developed to provide services covering different aspects of MPM, including Enterprise resource planning (ERP), Quality Management System (QMS), simulation platforms, etc. These software solutions can be interconnected with each other through web services or APIs. However, the interconnections are limited to the scope and interfaces specific to each individual service. The interconnections facilitate information exchange, but not knowledge inheritance. Techniques to map an innovation concept from the original idea to final product across the different phases of product life cycle are challenging. For example, process examples described in a patent application document may typically be device-independent and expressed in passive voice, while SOPs for manufacturing involves specific machine operations and are usually presented in active voice without subjects.

The breakthroughs in artificial intelligence (AI) and natural language processing (NLP) provide new tools to businesses and organizations across industries. However, it is considered an AI-hard problem to have machines understand and tell the differences between two similar ideas or methods described in documents or simulation models. Currently, human expert reading is needed to make precise comparison between two documents of high similarity score. Additionally, current AI-based techniques are not well-suited to extracting the knowledge, or information, in textual documents.

### SUMMARY

Example aspects of the present disclosure relate to a method, system, and computer storage media, which performs actions. The actions include obtaining a textual portion to be analyzed, the textual portion being associated with process; accessing a dependency tree associated with the textual portion, the dependency tree being generated via a forward pass through a natural language processing (NLP) model, and the dependency tree organizing the textual portion into nodes connected via connections, wherein individual nodes are associated with individual tokens reflected in the textual portion; generating one or more knowledge maps based on the dependency tree, wherein the knowledge maps organize the process into individual processes and individual materials, wherein entities are extracted based on the tokens, and wherein relationship information is used to relate the extracted entities to form the knowledge maps; and causing presentation, via an interactive user interface, of at least a portion of the one or more knowledge maps.

Example aspects of the present disclosure relate to a method, system, and computer storage media, which performs actions. The actions include accessing a textual portion, the textual portion reflecting a plurality of processes; obtaining a dependency tree based on the textual portion, the dependency tree being generated via a forward pass through a natural language processing (NLP) model, and the dependency tree organizing the textual portion into nodes connected via connections; updating the dependency tree to form an information tree, wherein individual nodes of the information tree are assigned a particular entity classification of a plurality of entity classifications; and generating one or more knowledge maps based on the information tree.

Example aspects of the present disclosure relate to a method, system, and computer storage media, which performs actions. The actions include accessing a dependency tree associated with a textual portion; determining an information tree based on the dependency tree, the information tree recognizing entities in the textual portion and removing one or more nodes of the dependency tree which have a particular type of connection; and generating one or more knowledge maps based on the information tree, the knowledge maps including one or more of: a first knowledge map which includes text of the textual portion organized into operation procedures, a second knowledge map which includes nodes reflecting processes described in the textual portion connected to nodes reflecting materials associated with the processes, or a third knowledge map which graphically depicts device configuration information associated with the processes.

Example aspects of the present disclosure relate to a method, system, and computer storage media, which performs actions. The actions include obtaining an input textual portion; generating, for presentation via a user device, an interactive user interface, wherein the interactive user interface: presents a first knowledge map which includes text of the textual portion organized into operation procedures, presents a second knowledge map which includes nodes reflecting processes described in the textual portion connected to nodes reflecting materials associated with the processes, and/or presents a third knowledge map which graphically depicts device configuration information associated with the processes.

### BRIEF DESCRIPTION OF THE DRAWINGS

FIG. 1A is a block diagram of an example knowledge extraction system determining a knowledge map based on a received document.

FIG. 1B is a block diagram illustrating detail of the knowledge extraction system determining a knowledge map.

FIG. 2 is a graphical illustration of an example knowledge map determined based on an input textual portion.

FIG. 3 is a flowchart of an example process to determine a knowledge map based on an obtained textual portion.

FIG. 4A is a flowchart of an example process to generate an information tree based on a dependency tree.

FIG. 4B illustrates dependency tags organized into different groups and used by the knowledge extraction system to generate the information tree.

FIG. 4C illustrates an example of adjusting a portion of a dependency tree as part of a process to generate an information tree.

FIG. 5 illustrates generating one or more knowledge maps based on an information tree and relationship information associated with nodes of the information tree.

FIG. 6A illustrates an example dependency tree.

FIG. 6B illustrates an example information tree determined based on the example dependency tree.

FIG. 6C illustrates example knowledge map(s) determined based on the example information tree.

FIG. 6D illustrates example knowledge map(s) which include operation procedure, process, and device configuration nodes.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction—Summary

The disclosed technology relates to techniques to extract, and organize, information from structured or unstructured text. Example text may include documents, manufacturing processes, chemical processes, manuals, governmental regulations, requirement documents, design documents, operation procedures, patents, and so on.

With respect to the example of a manufacturing process, the associated text may include complex descriptions identifying specific steps to be performed in specific sequences. At present, such text requires professionals to parse through the text and understand the specific steps. In contrast, using the techniques described herein a system may output succinct, and easy-to-understand, information that summarizes text while preserving all, or some, of the relevant information in the text.

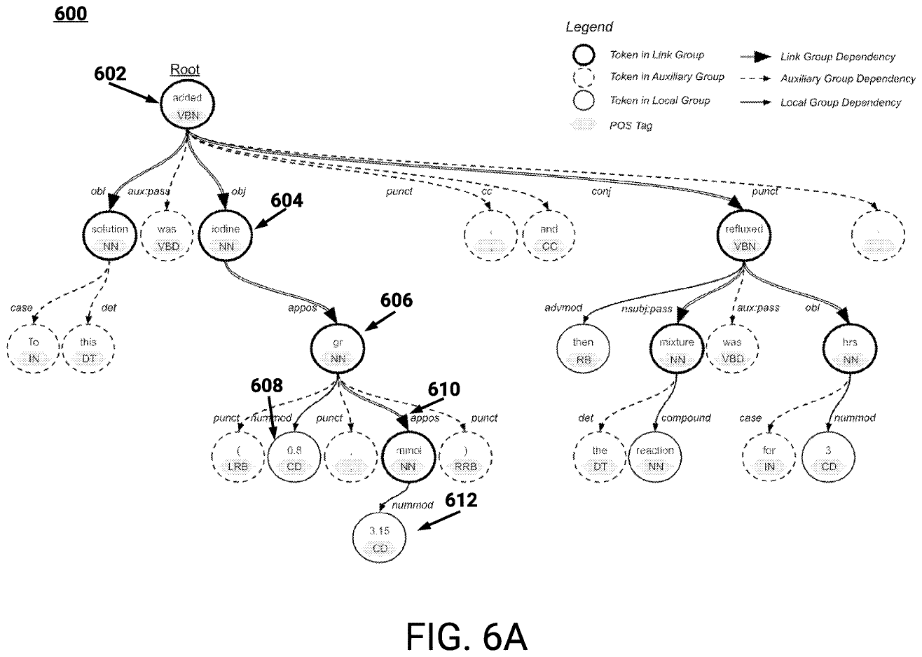

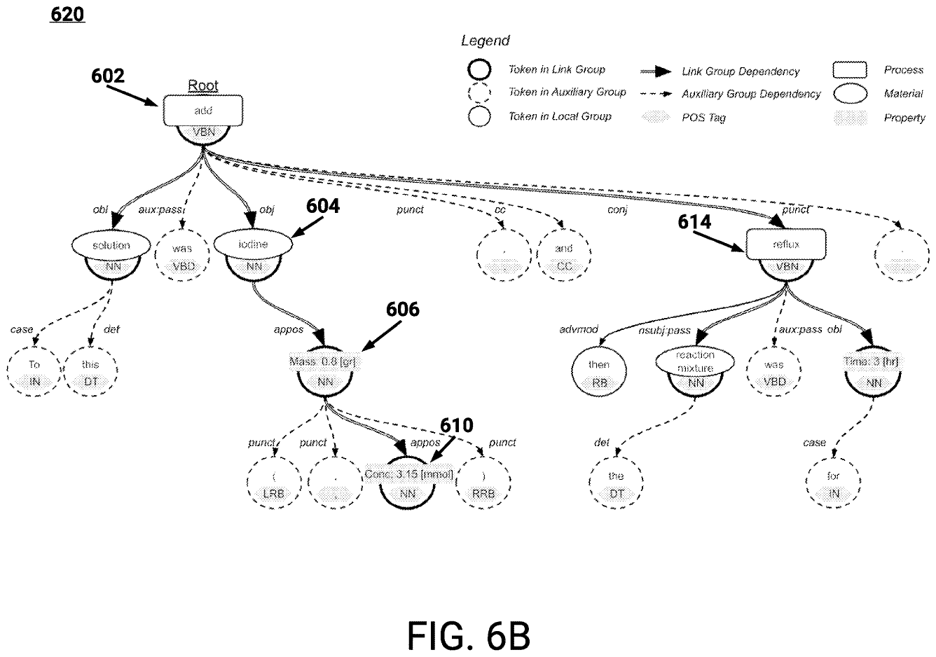

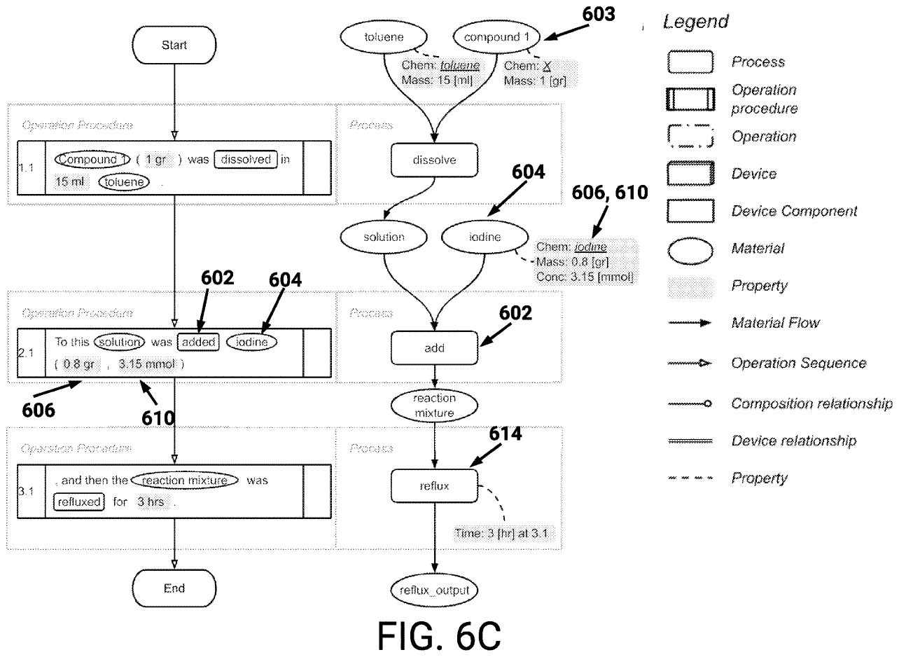

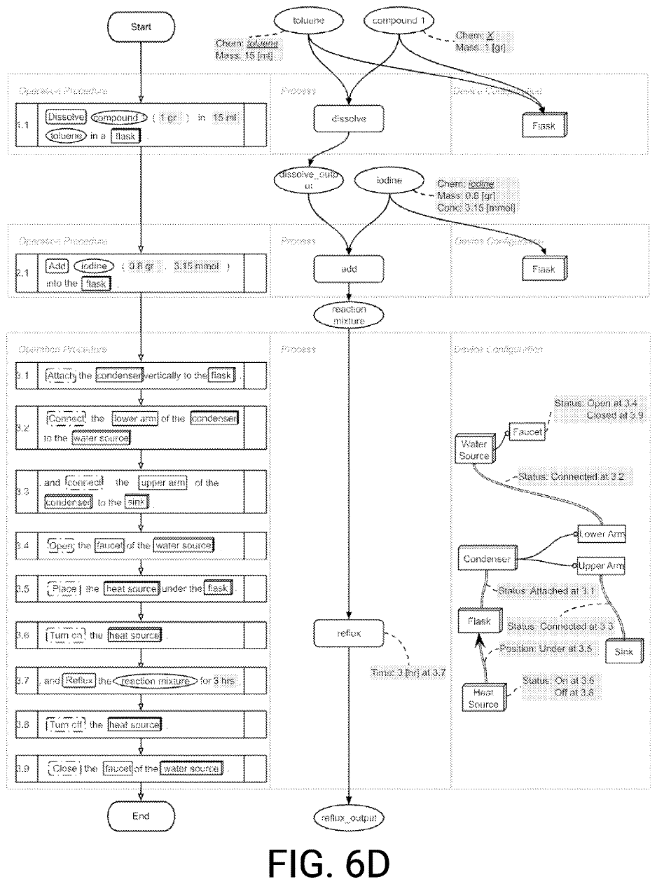

Specifically, the output may represent a knowledge map which characterizes the text as entities with specific relationships between the entities. For example, the entities may represent words recognized via machine learning, or rule-based techniques, which are relevant to a knowledge domain. As an example, entities may relate to specific process terms, material terms, device terms, and so on. The entities may be related to inform the specific processes, operations, and so on which are described in input text. For example, input text associated with chemical manufacturing may describe specific actions to be performed using disparate materials. In this example, the entities may describe an action (e.g., combine, add, mix), a material (e.g., solution, iodine, reaction mixture), and so on, and the knowledge map may relate them. Example knowledge maps are included in FIG. 6C and FIG. 6D.

Advantageously, such knowledge maps may be graphically presented to an end-user or, in some embodiments, may be provided to a system configured to perform a manufacturing process. For example, and with respect to FIG. 6D, a user may view a succinct overview of information included in a portion of text. In this example, the user may view text organized into different operations (e.g., on the left-side), the specific processes (e.g., in the middle), and the device configurations (e.g., on the right-side). Thus, complex textual portions may be converted into knowledge maps which allow for an easy-to-understand view of the information included in the textual portions.

As will be described, a system may leverage a natural language processing (NLP) model to process received text. For example, the NLP model may output a dependency tree which characterizes the dependencies between words, grammatical elements, and so on of input text. In this example, the NLP model may be trained to output information which the system may use to generate the knowledge map described herein.

Advantageously, the system may use specific rules, disparate domain information, and so on to inform the above-described knowledge map generation. In contrast, other natural language processing techniques may rely upon generative techniques, for example, large language models. These models are inefficient in terms of processing and are prone to inaccuracies introduced through the generative aspect of the model (e.g., hallucinations). Thus, the techniques described herein ensure efficient, and accurate, characterization of text into knowledge maps without the technical problems associated with generative techniques.

### Introduction—Knowledge Map(s)

As described above, the disclosed techniques may apply natural language processing (NLP) machine learning models (e.g., deep-learning models) or rule-based processes. Example NLP models are known by those skilled in the art and may be used for the techniques described herein. With respect to an NLP model, the NLP model may output NLP objects which include grammatical structures of the sentences, the dependency relationship between words, and lemma of each word for an input document. In some embodiments, and as illustrated in FIG. 6A, this information may be included in a dependency tree. The NLP model can be based on transformer, convolutional neural network, or any other technologies. The disclosed technology is not limited to any specific order of the NLP models. The NLP models process input text continuously on the base of phrases, sentences, or paragraphs.

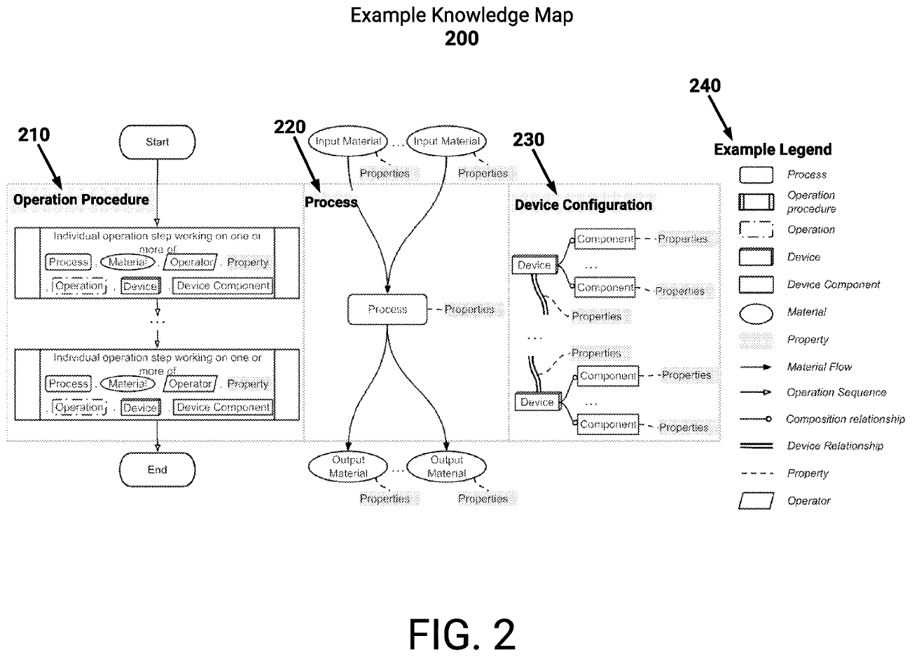

In some embodiments, and as described in FIG. 2, the dependency tree may characterize nodes, and connections between nodes, using different types of groups. These different types of groups may be user-definable, and the NLP model may be trained to perform the characterization. As an example, the dependency tree may include a link group which describes relationships between parent and child objects. The dependency information may further include an auxiliary group which facilitate recognition of a relationship between a parent and child object. The dependency information may further include a local group that describes a contribution to the expression or property of a parent object. As will be described, the local group may be used to characterize, or supplement, the parent object.

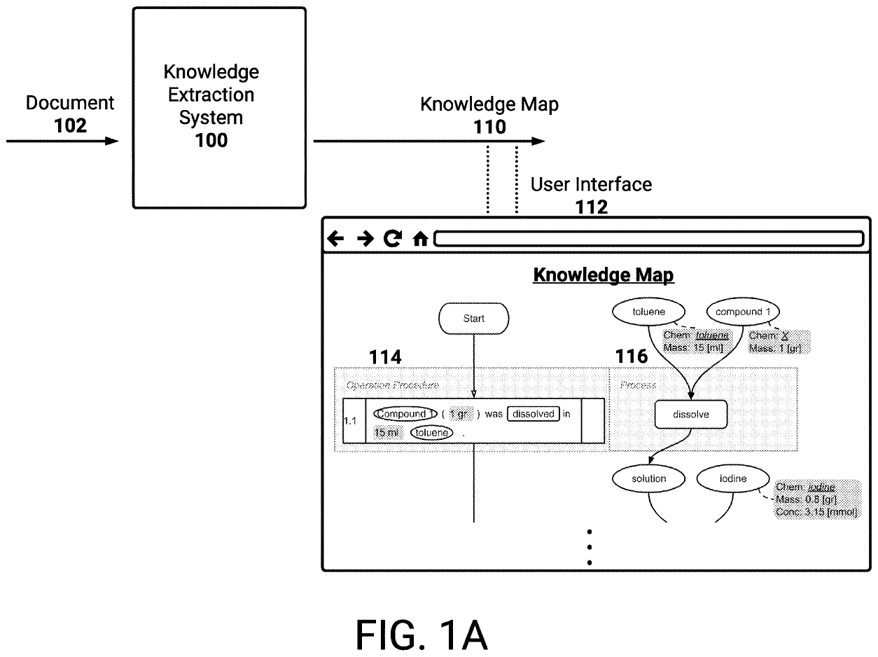

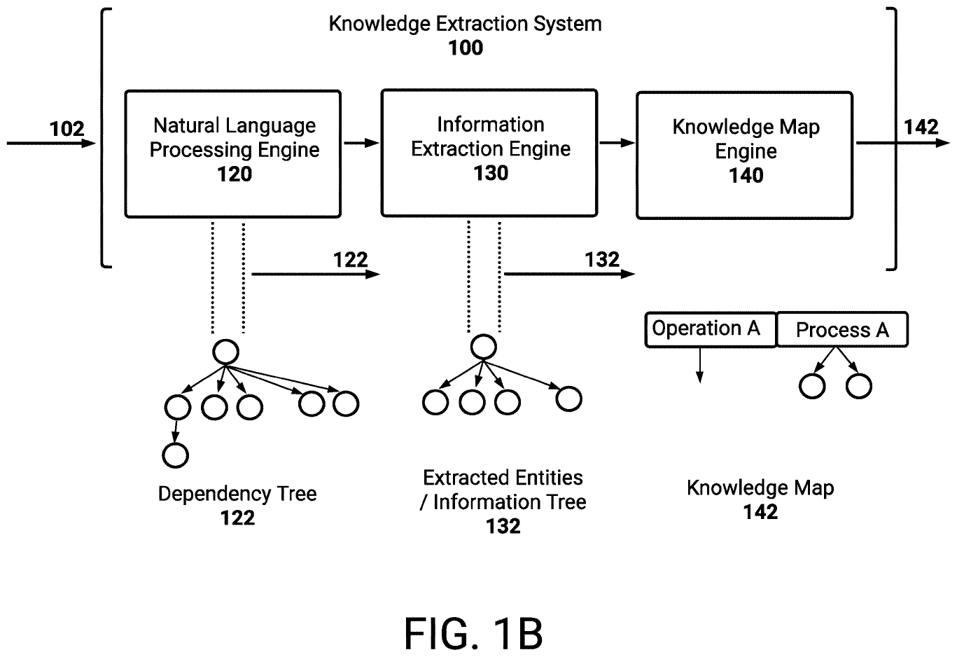

Based on the dependency tree, an information tree may be determined which extracts entities of interest based on a knowledge model. For example, and as illustrated in FIG. 1B, the system described herein may execute an information extraction engine to generate the information tree. As an example with respect to chemical processes, and as illustrated in FIG. 6B, the system may characterize the objects as being different types of information (e.g., process, material, property, and so on). For this example, the system may leverage specific knowledge domain which is usable to perform the characterization. The system may optionally deduplicate names of these objects, for example, using the above-described NLP model to ensure that different names may correspond to the same object.

In some embodiments, the above-described information tree may be determined from the NLP objects in a recursive manner via traversing the dependency tree (e.g., traversing from parent to child). In some embodiments, the dependency tree may be specific to a subset of input text (e.g., a sentence, multiple sentences, a paragraph, a sub-heading, and so on). To extract entities, an NLP named entity recognition model may be used and/or a rule-based technique. As known by those skilled in the art, the NLP model may be based on transformer, convolutional neural network, recurrent neural network, dense networks, or any other technologies.

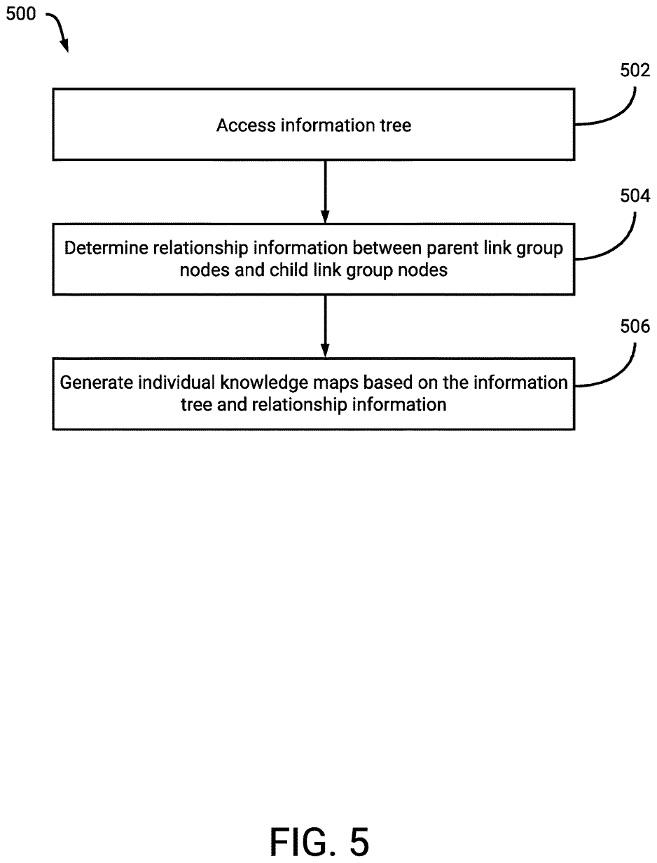

To determine a knowledge map, such as described in FIG. 5, relationships among the extracted entities may be determined. In some implementations, and as described above, subsets of text are processed individually to determine individual dependency trees. In these implementations interconnected knowledge maps may be constructed with respect to knowledge models via traversing the information tree of each subset. Relationship information may be determined using an NLP model and/or rule-based technique.

As will be described, the knowledge map may describe different aspects of information included in a portion of text. For example, a knowledge map may summarize the process steps described in the portion of text. In this example, and with respect to chemical manufacturing, the process steps may include actions (e.g., add, reflux) along with inputs, outputs, and so on. As another example, a knowledge map may include operation procedure information which may characterize words included in the portion of text. For this example, and as illustrated in FIG. 6A, portions of the input text may be assigned as different classifications (e.g., operations, materials, devices used and characteristics thereof, and so on). As another example, a knowledge map may include device configuration information. For this example, and with respect to the example of chemical manufacturing, the knowledge map may describe specific device configurations which are to occur. As an example, connections between different devices may be described. As another example, actions to be performed using devices may be described (e.g., a material may be input into a specific device).

Advantageously, such knowledge maps may be graphically presented to an end-user or, in some embodiments, may be provided to a system configured to perform a manufacturing process. For example, and with respect to FIG. 6D, a user may view a succinct overview of information included in a portion of text. In this example, the user may view text organized into different operations (e.g., on the left-side), the specific processes (e.g., in the middle), and the device configurations (e.g., on the right-side). Thus, complex textual portions may be converted into knowledge maps which allow for an easy-to-understand view of the information included in the textual portions.

The above, and other, features will now be described in more detail.

### Block Diagrams

FIG. 1A is a block diagram of an example knowledge extraction system 100 generating a knowledge map 110 based on a received document 102. The knowledge extraction system 100 may represent a system of one or more processors, one or more computers, one or more virtual machines executing on a system, and so on. In some embodiments, the knowledge extraction system 100 may represent a user device which is executing an application. Example user devices may include a wearable device, a laptop, a tablet, and so on. In some embodiments, the knowledge extraction system 100 may represent a server, or back-end system, which determines knowledge maps. For example, the system 100 may be associated with a web application in which a user may provide a document 102 for analysis. The system 100 may also respond to application programming interface (API) calls or endpoints to analyze documents.

As described herein, the knowledge extraction system 100 may analyze received documents (e.g., document 102) and generate knowledge map(s) 110 based on the document 102. A document may represent a textual portion, such as a manual, chemical manufacturing process, and so on as described herein. The document 102 may be in a markup language format, such as XML, HTML, and so on. The document 102 may also not be in a structured format. In some embodiments, the document 102 may analyzed (e.g., parsed) such as via object character recognition techniques to obtain a structure document.

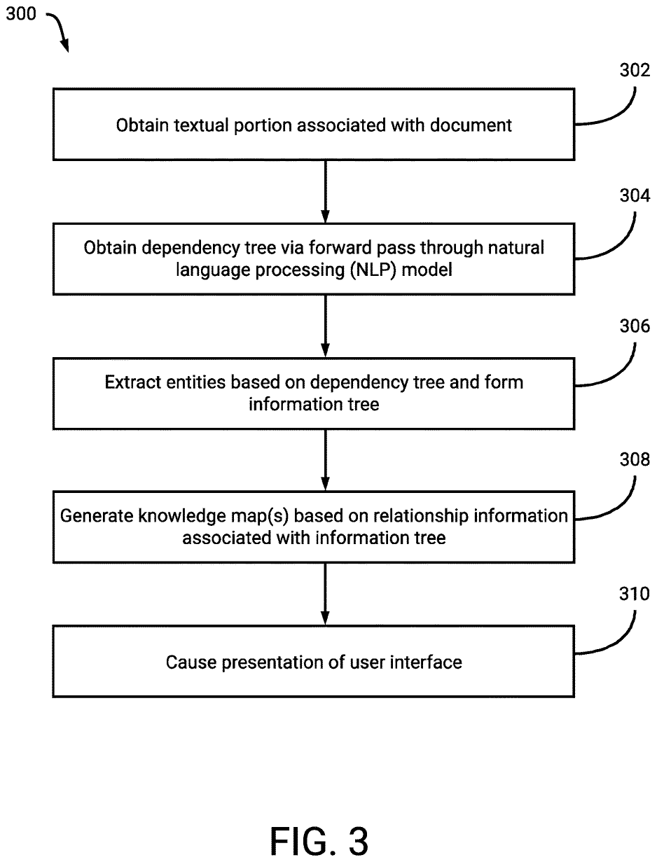

As may be appreciated, the document 102 may be organized into different portions such as headings, sub-headings, and so on. In some embodiments, the knowledge extraction system 100 may individually analyze these portions and optionally combine the analysis to form the knowledge map(s) 110. For example, the document title may represent a root element of structured document, with the headings, numbered/bulleted items, text/paragraphs, tables, figures, and other document elements representing children of the root. In some embodiments, the system 100 may recursively process the document 102 from the parent to the children. As an example, the system may start at the title, traverse to a child node (e.g., a sub-heading) and process the child node to extract knowledge information from the child node. Example knowledge information may include the text included in the child node tagged, or otherwise characterized, according to a classification scheme. Example knowledge information may additionally include a knowledge map. Extracting knowledge information is described in more detail below with respect to at least FIG. 3. Thus, the process described in FIG. 3 may be recursively performed in some embodiments.

As described above, a knowledge map 110 may preserve information included in the document 102 with the knowledge map 110 optionally being specific to a particular knowledge domain. To determine the knowledge map 110, one or more knowledge domain models may be used to inform the entities which relevant to the domain, relationships between the entities, and so on. For example, a manufacturing knowledge domain model may preserve information described in manufacturing process documents. As another example, a chemical process knowledge domain may preserve information described in a chemical processing document.

In some embodiments, the knowledge extraction system 100 may select one or more knowledge domain models. For example, the system 100 may analyze the document 102 to determine the appropriate models. In this example, the system 100 may execute a machine learning model which classifies the document 102 as corresponding to one or more knowledge domain models. The system 100 may also analyze the document 102 via identifying terms which are typically associated with a particular knowledge domain model. These knowledge domain models may be associated with NLP models and/or rule-based techniques to extract entities, determine relationships, and so on. For example, a first NLP model may be used for manufacturing while a second NLP model may be used for chemical processing. Thus, the system 100 may select a particular NLP model based on the knowledge domain model. As another example, a same NLP model may be used for all knowledge domains.

As described herein, the knowledge map 110 preserve information which may be spread throughout the document 102 and converts it into a form easily-digestible, sharable, and so on, by a user. For example, the system 100 may characterize entities included in the document 102 according to a classification which may be based on a knowledge domain model. An entity, as described herein, may refer to a word which is to be preserved in the knowledge map 110. Example entity classifications are included below with respect to Tables 1-3.

With respect to a manufacturing process, the classification may include one or more of a process, an operation procedure, an operation, a device, a device component, a material, a property, and so on. The knowledge map 110 may use these classifications of entities, and relationships between the entities, to generate succinct information from the document 102. For example, the knowledge map 110 may be included in a user interface 112 accessible to a user. In the illustrated embodiment, the user interface 112 includes a left-portion 114 which includes a portion of text from the document 102. This portion of text includes, ‘Compound 1 (1 gram) was dissolved in 15 ml toluene.’ As illustrated, the words of the text are graphically adjusted. While an example classification scheme is described below with respect to FIG. 2, by way of example the adjustment of Compound 1 and toluene may represent a ‘material’ classification and the adjustment of ‘dissolved’ may represent a process step. The right-portion 116 includes a graphical representation of process steps. For example, ‘dissolve’ is included a process step with materials above it representing the input and materials below it representing the output. Thus, in some embodiments the information from the left-portion 114 may represent the underlying knowledge information which is used to generate the right-portion 116.

FIG. 1B is a block diagram illustrating detail of the knowledge extraction system 100 determining a knowledge map 142. The knowledge extraction system 100 includes a natural language processing (NLP) engine 120 which may be trained to output a dependency tree 122 associated with input text (e.g., document 102). While an NLP engine is described, in some embodiments a rule-based engine may be used. The knowledge extraction system 100 further includes an information extraction engine 130 which determines an information tree 132 based on the dependency tree 122. The knowledge extraction system 100 further includes a knowledge map engine 140 which then outputs the knowledge map 142.

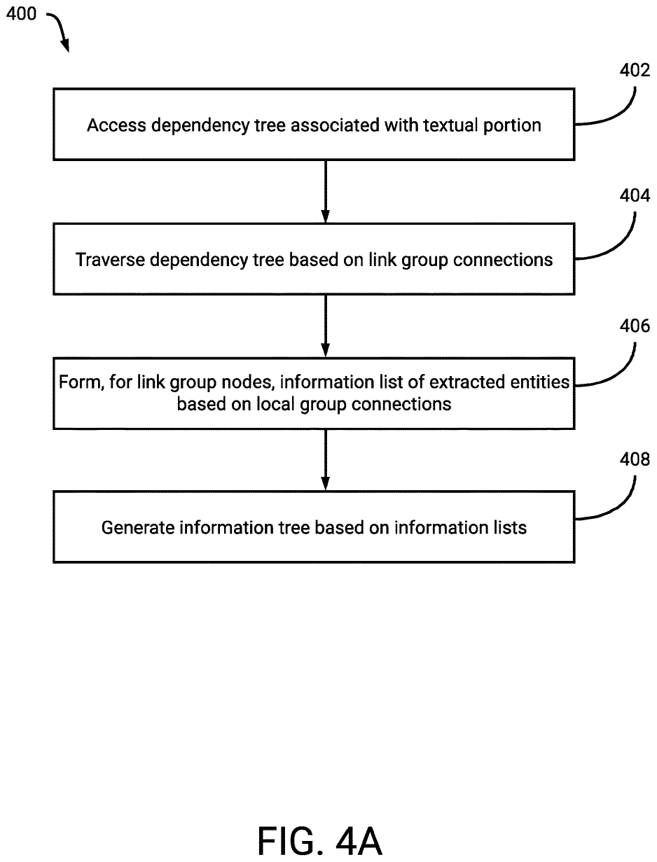

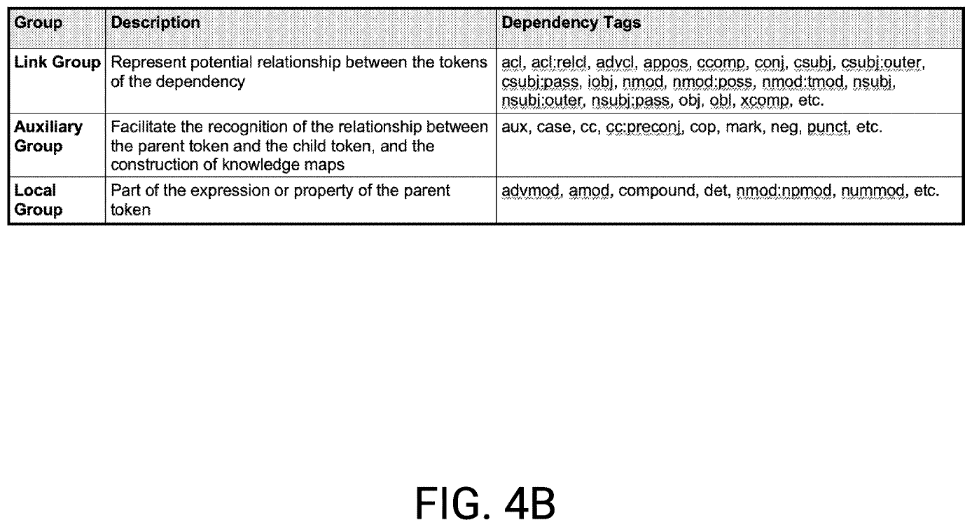

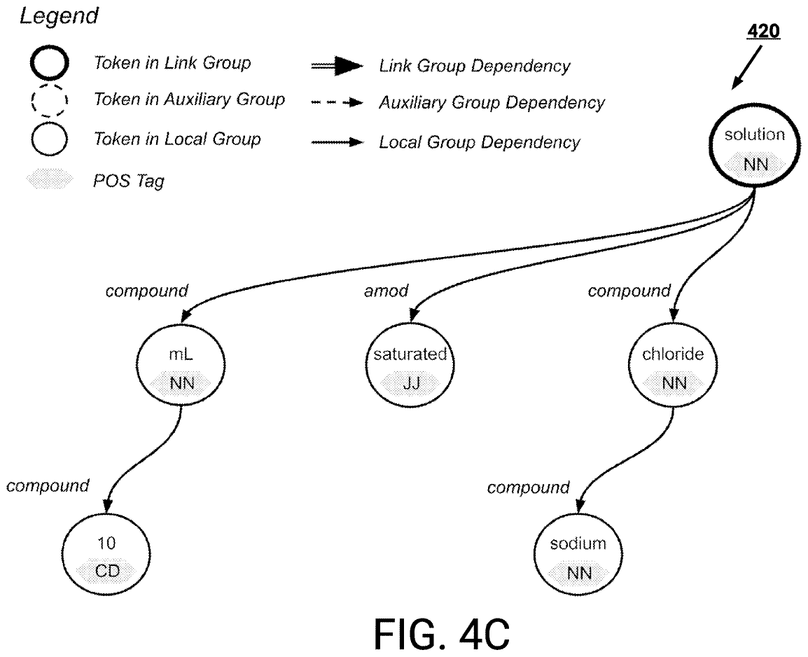

The NLP engine 120 may represent a model which enables processing of text. For example, the engine 120 may include a tokenizer which adjusts the text into tokens (e.g., segments the text into words, sub-words, punctuation, and so on). The engine 120 may additionally include a tagger which assigns word types to tokens (e.g., verb, noun, and so on). The engine 120 may additionally include a dependency parser which determines dependency information. Example dependencies are illustrated in FIG. 4B and described in more detail below. The engine 120 may additionally include a parser which parses the text based on the dependency information (e.g., the parser may describe relations between tokens). The engine 120 may additionally assign the base forms of words (e.g., determine lemmas of tokens), such as assigning ‘be’ instead of ‘was’ or ‘is.’ Example NLP engines may include spaCy, BERT, and so on as known by those skilled in the art.

The NLP engine 120 may be applicable to all natural languages and can work with any dependency tagging scheme as well as any part of speech (POS) tagging scheme. Examples of dependency tagging schemes include but are not limited to Stanford Dependencies, Google Universal Tags, ClearNLP Dependency Tags, and Universal Dependency. Examples of POS tagging schemes include but not limited to Penn Part of Speech Tags, and spaCy Fine-grained Tags. For simplicity purposes, English language, dependency scheme of Universal Dependency, and Spacy Fine-grained Tags are chosen to illustrate the system and method provided in this disclosure.

Thus, the NLP engine 120 may output a dependency tree 122. Nodes of the dependency tree 122 may represent tokens which have dependency information associated with them. For example, the dependency tree may be organized into parent and child nodes. As an example, a parent node may reflect an action (e.g., mixing) and child nodes may reflect materials which are to be mixed. From observations, it was found that certain dependency trees, such as trees corresponding to sentences of the document 102, may typically start with a verb, a noun, or an adjective as a root. Verb root typically indicates an action or a step, or a relationship between subjects and objects. Noun root can be a noun phrase used in titles, headings, or other numbered/bulleted lists, or a generalization of a subject in a sentence. An adjective is typically an attribute of a subject.

The information extraction engine 130 may analyze the dependency tree 122 to determine (e.g., extract) entities reflected in the tree 122. In some embodiments, the information extraction engine 130 may represent an NLP model which is trained to identify entities of interest. The engine 130 may additionally represent a rule-based engine which identifies entities. Example classifications used to extract entities are included in Tables 1-3 below. The engine 130 may thus identify whether a word included in the dependency tree 122 represents an entity. The engine 130 may additionally assign a classification (e.g., material, process, device, and so on).

TABLE 1

| | Entity | | |
|---|---|---|---|
| Category | Subcategory | Description | Examples |
| Material | Raw Material | A specific raw material, or its class/subclass | ginger, E. coli, bacteria |
| | Raw Material Part | Describe the part of the raw material | leaf, flower, root |
| | Chemical | A specific chemical element/ | dichloromethane, N,N- |
| | | compound/mixture/structure, or its class/subclass. | Dimethylformamide, fatty acids, |
| | | | receptor, surface receptor, |
| | | | polymer |
| | Process Output | Describe process output | mixture, solution, extract, |
| | | | distillate, isolate, concentrate, |
| | | | emulsion |
| | Product | Describe product | tincture, balm, oil, powder |
| Device | Device | A specific device used in a process, or its | reactor, condenser, container, |
| | | class/subclass | evaporator |
| | Device Component | Part of a device interacting with operators or other | inlet/output/port, switch, button, |
| | | devices | valve, control panel |
| Process | Process | Name of a manufacturing process | extraction, purification, |
| | | | dissolution, filtration |
| Device | Device | Name of a device operation | connection, attachment, |
| Operation | Operation | | configuration; |
| Operator | Operator | Name of roles operating on devices or running | operator, worker, engineer |
| | | processes | |
| Technology | Technology | Name of technology, or its class/subclass | chromatography, self- |
| | | | emulsification |
| Property | Quantifiable | Quantifiable properties with subcategories such as | 1.5 gr, 2.3 g, 500 mL, 100° C., |
| | Property | Mass, Volume, Concentration, Purity, Temperature, | 15%, 3 hrs, reduced pressure, |
| | | Pressure, pH, Percentage, Duration, etc. | room temperature |
| | Physical/Chemical | Describe a physical/chemical property of a material, | liquid, gas, solid; navy blue, |
| | Property | with subcategories such as State of Matter, Color, | water-soluble; saturated |
| | | Water-solubility, Saturation, etc. | |
| | Manner | Describe the manner of a step or action | slowly, dropwise manner |
| | Enumerated | State of a device, a device component, or a | on/off; high/medium/low |
| | Property | process, typically with a predefined list of values | |
| Numbered | Numbered | A reference for a numbered heading, section, or list | example 1, step 2, section 2.3, |
| Item | Item | item in the document, usually appear before the | previous step, first step |
| | | reference occurs | |

TABLE 2

| Unit Category | Unit Subcategory | Description | Example |
|---|---|---|---|
| Class | type, kind, class, group, category, species, | Classification with respect to | type, kind, class, group, |
| | strain, variety, etc. | certain property or concept | category, species, strain, |
| | | | variety |
| Procedure | Procedure | Repetition of a procedure | time, iteration, repeat, round |
| Repetition | Repetition | | |
| Quantifiable | Mass, Volume, Concentration, Purity, | Unit for a corresponding | km, mL, hour, hr., cm, ° C., % |
| Property Unit | Temperature, Pressure, pH, Percentage, | quantifiable property | |
| | Duration, etc. | | |

TABLE 3

| Verb | Verb | | |
|---|---|---|---|
| Category | Subcategory | Description | Examples |
| Procedure | Process Verb | A verb representing a step in which | freeze, cool, heat, stir, mix, wash, reflux, react, |
| Verb | | chemical or physical changes | crystalize, dissolve, dilute, distill, dry, filter, evaporate, |
| | | happen to the materials | pour, add, combine, extract, purify, concentrate, |
| | | | separate, grind, inject, spray, synthesize, |
| | | | biosynthesize, produce |
| | Device | An operation on devices to make | connect, disconnect, remove, attach, detach, put, |
| | Operation | connection between devices, set | open, close, turn, choose, click, switch, set, configure, |
| | Verb | parameters, transfer material from | move, transfer |
| | | one device to another, etc. | |
| Relationship | Sequence | A verb indicates the relative | precede, follow |
| Verb | Verb | sequence between subject and | |
| | | objects | |
| | Composition | A verb representing composition | Include, consist, compose, contain, have, belong |
| | Verb | relationship between the subject | |
| | | and objects. | |
| Outcome Verb | Outcome Verb | A verb representing outcomes | provide, give, yield, afford, supply, get, obtain |

The information extraction engine 130 thus identifies entities reflected in the dependency tree. Additionally, the information extraction engine 130 may adjust the tree 122 to form an information tree 132. For example, the information included in certain child nodes may be moved into parent nodes. In this example, child nodes which have information which contributes to the expression or property of the entity associated with a parent node may be combined into the parent node. This information is referred to herein as a local group, and local group connections are described below with respect to FIGS. 4A-4B. The information associated with a node may be referred to herein as an information list. This information list of entity may include entities recognized for a sub-tree of the node (e.g., child nodes of the node).

The knowledge map engine 140 may determine relationship information for the entities identified in the information tree 132. For example, example relationship information is included in Tables 4-5 below which are described in FIG. 5. In some embodiments, an NLP model may determine this relationship information. In some embodiments, a rule-based engine may determine the relationship information. An example relationship may include a parent node being a process verb and a child node being a noun indicating a material or device. With respect to the example of a material, the relationship may indicate that the material is an input to output of the process. With respect to the example of a device, the relationship may also indicate that the device is correlated to the process (e.g., used in the process).

Based on the relationship information, the knowledge map engine 140 may generate knowledge information. For example, the knowledge information may include an indication of knowledge map nodes which correspond to certain entities in the information tree 132. In some embodiments, the knowledge map nodes may correspond to entities which are one or more of processes, operation procedures, operations, devices, device components, and/or materials. These types of entities are illustrated in FIG. 2 with respect to the Legend portion (e.g., portion 240). As described above, each entity may have an information list which may reflect child entities. Based on the relationship information, this information list for a node may be linked to the corresponding text in the document 102. For example, in the left-portion 114 illustrated in FIG. 1A may reflect this relationship information between nodes. Additionally, the relationship information and information lists may be used to generate the right-portion 116 of FIG. 1A. For example, the material ‘compound 1’ in FIG. 1A may reflect a parent node with an information list that includes the chemical makeup and physical properties (e.g., mass). As will be described below with respect to FIG. 4A-4B, the information list may include information from child nodes which are connected via local group connections. Furthermore, and as illustrated in FIG. 2, a device configuration portion (e.g., portion 230) may be determined based on relationship information and information lists.

FIG. 2 is a graphical illustration of an example knowledge map 200 determined based on an input textual portion. Specifically, FIG. 2 illustrates an example of a manufacturing process knowledge model. In this example, each process step correlates to one or more input materials, one or more output materials, a set of devices in which the process step happens, and a set of operation procedure steps to prepare, run, and finish the process step.

There are three types of knowledge maps in this example: operation procedure map (e.g., portion 210), process map (e.g., portion 220), and device configuration map (e.g., portion 230). Operation procedure map describes the sequences of individual device operations and/or material process steps in natural language. Process knowledge map describes how materials change through process steps, including material nodes and process nodes. Each process node has properties, and each material used in the process node (e.g., an input or output) has a list of properties which are updated by corresponding process steps. For example, a property may reflect a temperature and the process node may cause a change in temperature of the material. Device configuration map describes how the devices are configured and operated to complete each process step. Each device or device component has properties, and each property has a list of property values which are updated by corresponding device operation steps. Initial preparation and maintenance of devices in the operation procedure may not be correlated to a specific process step if they are not involved in process steps.

Processes and device operations can be expressed or referenced in either verb form or noun form. For example, extract (presented as a verb in the text, not the noun representing the output of the extraction process) is a verb for the extraction process. For simplicity and unification, each process is denoted in verb form. The mappings between verbs and their corresponding nouns are maintained in a lookup table. In case a process step or a device operation is expressed as a noun, its corresponding verb will be obtained by searching lookup table and used as the name of the process step or device operation in knowledge map. Operations normally change the attributes of the operation target. For example, “Set the temperature of the reactor to 100° C.” changes the property “temperature” of the reactor to value “100° C.”. Some device operation verbs indicate the status changes. Mappings between the device operation verb/noun (may include adverbs) and status are maintained in a look-up table. In this way, device operation results are reflected in property values of the operation target. For example, “Close the valve” changes the value of the property “Operation Status” to “closed” for the device “valve”.

### Example Flowchart

FIG. 3 is a flowchart of an example process 300 to determine a knowledge map based on an obtained textual portion. For convenience, the process 300 will be described as being performed by a system of one or more computers (e.g., the knowledge extraction system 100).

At block 302, the system obtains a textual portion associated with a document. The system may obtain a portion of a document, such as a sentence, a paragraph, text under a sub-heading, or the entire document. As described herein, these portions may be individual processed and combined to form output for the document.

At block 304, the system obtains a dependency tree. In some embodiments, a natural language processing (NLP) model may be used to determine the dependency tree. Thus, the system may compute a forward pass through the NLP model based on the obtained textual portion. As described herein, the dependency tree may assign a type to a word (e.g., verb, noun) and optionally dependencies between words. For example, the dependencies may indicate whether a child node has a conjunctive relationship with a parent node indicating an order (e.g., the child node may describe an action or material which occurs prior to, or after, the parent node). As another example, the dependencies may indicate that a child node is an adverb modifier of a parent node. Example dependencies are illustrated in FIGS. 4B-4C and 6A-6B (e.g., ‘obj’ or object, ‘appos’ or apposition modifier, ‘obl’ or oblique argument or adjunct, and so on).

At block 306, the system extracts entities based on the dependency tree and forms an information tree. The system may identify, or otherwise recognize, entities based on the dependency tree. For example, the tree may include tokens (e.g., words) which are connected according to different dependency connections. These connections are described below with respect to FIG. 4B. The system may thus traverse the tree, optionally recursively, and identify entities based on the traversal. For example, the system may assign an entity classification (e.g., process, material, device, device configuration, and so on as described herein). Examples of entities are included in Tables 1-3.

At block 308, the system constructs (e.g., determines, generates) knowledge maps based on the information tree. The system uses relationship information, such as included in Tables 4-5 below, to relate the entities identified in the information tree. These relationships inform the particular information which is to be included in the knowledge maps. For example, the relationship information may indicate that a parent node represents a process to be applied to, or which uses, child nodes. In this example, the parent node may reflect a particular type of entity (e.g., a process verb) and the children may reflect particular types of entities (e.g., materials). The knowledge map may be determined via identifying knowledge map nodes which correspond to link group nodes. The knowledge map nodes may reflect particular types of entities as described herein (e.g., processes, materials, and so on). Additionally, the system may, in some embodiments, deduplicate the nodes to ensure that a single knowledge map node corresponds to multiple uses of an entity (e.g., the same compound may be referenced for use in different portions of input text). Deduplication may be based on the name, vector space representation of the associated word or token, and so on.

Thus, a knowledge map may include the above-described relationship to succinctly indicate the process and associated inputs/outputs. Advantageously, this information may have been spread around the input textual portion and the system may determine the relationship for ease of user understanding.’

At block 310, the system causes presentation of a user interface. The system may present the knowledge maps in a user interface to a user. Thus, the user may view easy-to-understand complex information in a digestible format rather than reading lengthy documentation. In this way, errors may be reduced as the user may rely upon the knowledge map rather than parsing complex documentation. As described in FIG. 2, there may be different types of knowledge maps which present different information. For example, operation procedure maps, process maps, device configuration maps, and so on.

In some embodiments, the knowledge maps may be provided to a system to automate manufacturing or chemical processing. For example, the system may take actions identified in the process map. The system may also configure devices used for the manufacturing or processing according to the device configuration map.

FIG. 4A is a flowchart of an example process 400 to generate an information tree based on a dependency tree. For convenience, the process 400 will be described as being performed by a system of one or more computers (e.g., the knowledge extraction system 100).

At block 402, the system accesses a dependency tree associated with a textual portion. As described above, the system generates a dependency tree based on dependencies assigned by a machine learning model or rule-based engine. Example dependencies are illustrated in FIG. 4B.

FIG. 4B illustrates dependency tags organized into different groups and used by the knowledge extraction system to generate the information tree. The disclosed technology divides dependency relations in NLP into three categories: link group, auxiliary group, and local group. The example tags are with respect to Stanford dependency tags (e.g., spaCy tags), although other tags may be used and fall within the scope of the disclosure herein.

These tags are known by those skilled in the art and not reproduced herein. However, as an example the ‘acl’ tag may represent an adjectival complement. The ‘advcl’ tag may represent an adverbial clause modifier. The ‘nmod’ tag may represent a modifier of nominal. The ‘nsubj’ tag may represent a nominal subject. The ‘obj’ tag may represent an object tag. The ‘obl’ tag may represent an oblique normal. The ‘neg’ tag may represent a negation modifier. The ‘advmob’ tag may represent an adverbial modifier. The ‘amod’ tag may represent an adjectical modifier. The ‘nummod’ tag may represent a numeric modifier.

Examples of the above-described tags are illustrated in FIG. 4C (e.g., amod, compound) and FIGS. 6A-6B (e.g., obl, case, det, appos, punct, conj, nsubj: pass, and so on). Thus, the dependency information may include assignment of these tags (e.g., assignment between word connections).

The tags in the link group typically represent a knowledge map relationship between the two entities represented by the parent token and the child token. The entities defined in the disclosed technology include but are not limited to entities in normal definition (real-world object), process/operation entities represented by corresponding verbs, properties, property values, and other things of interest to the defined Knowledge models.

The tags in the auxiliary group are usually used to facilitate the recognition of the relationship between the parent token and the child token as well as the determination of references.

The tags in the local group normally contribute to the expression or property of the object represented by parent token. The tags in the local group usually connect child tokens which in turn connect their child tokens only with tags in the local group. Therefore, by recursively traversing through the dependency tags in the local group, a continuous span of a text will be formed, which is used in the disclosed technology to extract the entities and other information with exceptions such as nested entities.

At block 404, the system traverses the dependency tree based on link group connections. The system may initiate at a root node of the tree and traverse to child nodes which have link group connections. In some embodiments, the processing may be effectuated recursively. The system may additionally analyze the dependency tree to identity entities, for example as described above with respect to FIG. 1B.

Specifically, entities may be recognized using an NLP mode, a rule-based approach, a look-up table (e.g., optionally specific to a knowledge domain), and so on. The system determines whether text in a node is recognized. If it is determined that the text is recognized, the recognized entity is added together with its category or subcategory to the information list of the current node. The system then determines whether the current node has at least one child with a local group connection. If it is determined that the current node has at least one child with a local group connection, the system continues with another determination regarding if nested entity situation happens in the span formed by the current token and its children. If it is determined that nested entity situation happens, the system recognizes the nested entities. If it is determined that nested entity situation does not happen, the system gets the next nearest child node with a local group connection (e.g., to recursively extract information). The information list of the returned child node is obtained and appended to the information list of the current node.

At block 406, the system forms information lists for link group nodes based on local group connections. The local group connections may represent contributions to an expression or property of an entity associated with a parent. For example, a child node indicating a value may be connected via a local group connection for a parent indicating a measurement type (e.g., millimolar). The system may collapse, trim, or otherwise remove the child node. Specifically, the system may update an information list for the parent node to include the information in the child node. Additionally, a parent node connected via link group connections to child nodes may have their information lists updated to include the entities in their span (e.g., the parent node's information list may include the entities identified in the child nodes).

At block 408, the system generates an information tree based on the information lists 408. As described in block 406, the system may adjust the tree to remove child nodes which have local group connections to parent nodes. Additionally, the system may associate information lists to each link group node having at least one local group connection to a child node. The child node may be removed such that the tree is truncated.

FIG. 4C illustrates an example of adjusting a portion of a dependency tree 420 as part of a process to generate an information tree. In the illustrated example, the portion of the dependency tree 420 includes a root node (e.g., ‘solution’) and child nodes (e.g., ‘ml’, ‘saturated,’ and ‘chloride’) with ‘ml’ having child node ‘10’ and ‘chloride’ having child node ‘sodium’.

In the example, the connections between the parent nodes and child nodes are local group connections. The system may initiate processing at the root node in some embodiments. Additionally, the system may recursively analyze the tree 420 in some embodiments such that it may traverse first to ‘chloride’ and then to ‘sodium.’ As described herein, the system may identify the entity ‘sodium’ based on a chemical manufacturing or processing knowledge domain. The information from this child node may be moved upward to its parent node (e.g., ‘chloride’). Thus, the information may reflect ‘sodium chloride’). The system may determine whether ‘sodium chloride’ should be moved upward to the parent ‘solution.’ To effectuate this determination, the system may determine whether ‘sodium chloride solution’ is a recognized entity. In this example, the system will determine that ‘sodium chloride’ is an entity but not ‘sodium chloride solution.’ Thus, the system will update the information for the root “solution.’

For example, the information list for the root (e.g., ‘solution’) may therefore include ‘solution’ and ‘sodium chloride.’ Similarly, the system may traverse to node, ‘saturated’. Since this does not have a child node, the system may determine whether ‘saturated’ should be moved upward to ‘solution.’ Similar to the above, the system will instead append ‘saturated’ to the information list for ‘solution.’ The system may then traverse to ‘ml’ and ‘10’. Since ‘10 ml’ may reflect an entity (e.g., as noted in Tables 1-3 with respect to, for example, quantifiable property), the system will combine these nodes. The system will then append ‘10 ml’ to the information list for solution (e.g., 10 ml solution will not be recognized as an entity).

Thus, the information list for node ‘solution’ may include the following entities (e.g., along with example classifications of the entities):
“10 mL” (Property|Quantifiable Property|Volume)
“saturated” (Property|Physical/Chemical Property)
“sodium chloride” (Material|Chemical)
“solution” (MateriallProcess Output)

FIG. 5 is a flowchart of an example process 500 for generating one or more knowledge maps based on an information tree and relationship information associated with nodes of the information tree. For convenience, the process 500 will be described as being performed by a system of one or more computers (e.g., the knowledge extraction system 100).

At block 502, the system accesses an information tree. As described in FIGS. 4A-4C, the information tree may include nodes with recognized entities along with information lists for the entities.

At block 504, the system determines relationship information between parent link group nodes and child link group nodes. The system identifies parent link group nodes which, in some embodiments, may be of certain types. For example, these nodes may reflect entities which are one or more of processes, operation procedures, operations, devices, device components, materials, and so on.

The system determines relationship information between nodes. For example, Tables 4-5 describe example relationships:

TABLE 4

| | Parent's | | | |
|---|---|---|---|---|
| | Auxiliary | | | |
| Parent | Tags | Child | Child's Auxiliary Tags | Relationship |
| process verb | | material/device [Noun] | | material/material in device as input |
| [Verb] | | <obj> | | or output of process, determined by |
| | “be” [Verb] | material/device [Noun] | | process verb |
| | <aux> | <nsubj:pass> | | |
| | | material/device [Noun] | | |
| | | <obj> | | |
| | | material/device [Noun] | “to”/“into”/“onto”/“with”/“from”/etc. | |
| | | <obl> | [IN] <case> | |
| | | property value [Noun] | “for”/“at”/etc. [IN] <case> | property value as property value of |
| | | <obl> | | process |
| | | operator [Noun] <nsubj> | | operator as owner of process |
| | | operator [Noun] <obl> | “by” [IN] <case> | |
| | | technology [Noun] <obl> | “by” [IN] <case> | technology as a property of process |
| | | outcome verb [VB] | “to” [TO] <case> | material from outcome verb as |
| | | <advcl> | | output of process |
| | | outcome verb [VBG] | | |
| | | <xcomp> | | |
| process verb | “be” [Verb] | process verb [VBN] | | child process follows parent process |
| [VBN] | <aux> | <conj> | “and” [CC] <cc> | |
| outcome verb | | material [Noun] <obj> | | material as output; |
| [VB/VBG] | | property value [Noun] | “as” [TO] <case> | property value as property value of |
| | | <obl> | | material |
| process | | material [Noun] <nmod> | “with”/“on”/“of”/etc. [IN] <case> | material as input or output of |
| [Noun] | | | | process, determined by the process |
| process | | material [Noun] <nmod> | “of”/“in”/“with”/etc. [IN] <case> | process output as output of process |
| output [Noun] | | | | with material as input |
| material | | property value [Noun] | “(“/”)”[LRB/RRB] <punct> | property value as property value of |
| [Noun] | | <appos> | | material |
| | | material [Noun] <appos> | “(“/”)”[LRB/RRB] <punct> | child material as alias of the parent |
| | | | | material |
| | | process verb [VBN] | | material as output of process |
| | | <acl/acl:relcl> | | |
| property value | “,” [,] <punct> | property value [Noun] | | child property value appends the |
| [Noun] | | <appos> | | parent property value |
| <appos> | | | | |
| property value | | material [Noun] <nmod> | “of” [IN] <case> | Material has property with property |
| [Noun] | | | | value |
| Property value | “be” | material/process/device | | property value as property value for |
| [JJ] | [Verb]<cop> | [Noun] <nsubj> | | material/process/ device |
| composition | | material, process, | | whole vs parts, determined by the |
| verb [VB] | | device [Noun] <nsubj>; | | verb, its POS and dependency |
| | | material, process, or | | |
| | | device [Noun] <obj> | | |
| sequence verb | | process/operation | “by” [IN] <case> | child process/operation is before or |
| [VBN] | | [Noun] <obl> | | after grandparent process/operation, |
| | | | | determined by the sequence verb |

TABLE 5

| | Parent's | | | |
|---|---|---|---|---|
| | Auxiliary | | Child's Auxiliary | |
| Parent | Tags | Child | Tags | Relationship |
| composition verb | | material, process, device | | whole vs parts, determined by the |
| [VB] | | [Noun] <nsubj>; | | verb, its POS and dependency |
| | | material, process, or device | | |
| | | [Noun] <obj> | | |
| sequence verb [VBN] | | process/operation [Noun] | “by” [IN] <case> | child process/operation is before or |
| | | <obl> | | after grandparent process/operation, |
| | | | | determined by the sequence verb |
| operation verb [Verb] | | operator [Noun] <nsubj> | | operator as owner of operation |
| connection verb | “be” [Verb] | device/device component | | device/device component is connected |
| [Verb] | <aux> | [Noun] <nsubj:pass> | | to another device/device component |
| | | device/device component | | |
| | | [Noun] <obj> | | |
| | | device/device component | “to”/etc. [IN] <case> | |
| | | [Noun] <obl> | | |
| configuration verb | “be” [Verb] | property [Noun <nsubj:pass> | | property is set to property value |
| [Verb] | <aux> | | | |
| | | property [Noun] <obj> | | |
| | | property value [Noun] <obl> | “to”/etc. [IN] <case> | |
| device component | | device [Noun] <nmod> | “of”/“on”/“in”/etc. | device component is part of device |
| [Noun] | | | [IN] <case> | |
| entity [Noun/JJ] | | entity with similar category as | | child appends the inclusive/alternative |
| | | parent [Noun/JJ] <conj> | | entity list starting with parent, |
| | | | | depending on “and” or “or” |
| | | | “and” [CC} <cc> | child appends the inclusive entity list |
| | | | | starting with parent |
| | | | “or” [CC} <cc> | child appends the alternative entity list |
| | | | | starting with parent |
| process verb [VBN] | | numbered item | “in” [IN] <nmod/obl> | parent is a reference to the |
| outcome verb [VBN] | | | | corresponding object in child region |
| process [Noun] | | | | |

At block 506, the system generates individual knowledge maps based on the relationship information and information tree. For example, the relationship information indicates relationships between parent nodes and all link group child nodes.

The system may determine information reflecting an order or ordering associated with the input textual portion. For example, a conjunct token list may be created which indicates conjunct dependency and relationship introduced by a sequence verb. A non-conjunct token list may be created to include all the non-conjunct link group child nodes. In this example, the conjunct token list may include actions (e.g., processes) which occur after, or prior to, an action (e.g., process) of a parent node. An example of this list may be understood with reference to FIG. 6B. For example, a root (e.g., 602) may indicate that two materials are added and a child node (e.g., 614) may indicate that the result of the adding is refluxed.

Thus, in FIG. 6B the conjunct token list may include ‘add’ and ‘reflux’. Each conjunct token list may have an associated non-conjunct token list. In the example, the non-conjunct token list for reflux may include the children (e.g., children connected via link group dependencies).

The system may obtain a node identified in the non-conjunct token list. These nodes may be processed, for example to determine relationship information. Additionally, and as described herein, information lists of parent nodes may be updated to include information from child nodes. The system may then identify a next conjunct node and process the child nodes from the associated non-conjunct token list. The system may continue until the conjunct nodes are processed.

While the description above focused on a conjunct token list including processes (e.g., actions, such as add or reflux). As may be appreciated the conjunct token list may include other types of words. For example, materials may be identified in a conjunct token list. As an example, there may be a process to add chemical 1 to a substance. For this example, a textual portion may indicate that chemical 2 is then added. Similarly, the textual portion may indicate that chemical 3 is then added. Thus, there is an ordering of the addition of these chemicals. In this example, the conjunct token list may thus include the chemicals in the above-described order such that the system understands their order.

In some embodiments, the system may determine that the obtained textual portion has both process and operation type knowledge nodes. The system may then correlate each process node to the procedure nodes operating on the devices. For example, the system may search the device in which the process material is in for its currently connected devices. The operation procedure steps on the currently connected devices between the last operation procedure step of the previous process node and the current process node are assigned to the current process node. The operation procedure steps on the currently connected devices between the current process node and the next process node are assigned to the current process node.

Thus, the system may generate knowledge maps based on the particular link group nodes. For example, the system may determine relationships between processes, materials, and properties thereof. For processes, the system may generate a knowledge map similar to that illustrated in portion 220 of FIG. 2. For example, the system may determine that a process is related to particular materials. In this example, the information lists may inform properties of the materials (e.g., these properties may have been local group connections to the materials). The system may also generate a knowledge map similar to that illustrated in portion 210 of FIG. 2. For this example, the system may tag, or otherwise characterize, words of the textual portion based on the relationship, and information lists, described herein.

FIG. 6A illustrates an example dependency tree 600. This tree may have been generated by an NLP model based on input of, “To this solution was added iodine (0.8 gr, 3.15 mmol), and then the reaction mixture was refluxed for 3 hrs.”

Thus, the tree 600 has a root node 602 of ‘added.’ The NLP model has determined that this represents the root of the sentence since, as an example, it reflects the initial action to be performed. A child node 604 (e.g., ‘iodine’) is connected via a link group dependency to child node 606 (e.g., ‘grams’) which is connected via a local group dependency to child node 608 (e.g., ‘0.8’) and a link group dependency to child node 610 (e.g., ‘mmol’). Child node 610 is connected via a local group dependency to child node 612 (e.g., ‘3.15).

FIG. 6B illustrates an example information tree 620 determined based on the example dependency tree 600. The information tree 620 illustrates example entity classifications. For example, root node 602 has been recognized as an entity which is a process. Its child node 604 has been recognized as an entity which is a material. Child node 606 has been recognized as an entity which is a property. Child node 610 has been recognized as an entity which is a property. In some embodiments, the processing may be performed recursively.

As illustrated, child node 608 has been removed from the tree 620. For example, and as described above with respect to FIGS. 4A-4C, the local group connection may cause the system to append the information from node 608 onto the information list for node 606. Thus, node 606 now reflects a combination (e.g., ‘0.8 grams’).

FIG. 6C illustrates example knowledge map(s) determined based on the example information tree. The operation procedures knowledge map includes the sentence identified above in the middle and bottom with respect to procedures 2.1 and 3.1. Additionally, the map includes a prior sentence, “Compound 1 (1 gram) was dissolved in 15 ml of toluene.” As described above, in some embodiments the system may analyze a portion of text at a time (e.g., one sentence at a time, one paragraph, and so on). Thus, this first process may be included as operation procedure 1.1.

In the illustrated example, operation procedure 1.1 includes reference to two materials (e.g., toluene and compound 1), with the two materials being inputs. Operation procedure 2.1 includes reference to two materials (e.g., solution and iodine), with the two materials being inputs. Operation procedure 3.1 includes reference to one material (e.g., reaction mixture). The system may, in some embodiments, assume that a process has at least one input. The system may, in some embodiments, assume that a process has at least one output. Thus, for operation procedure 1.1 the system may analyze the sentence and create an output associated with the dissolving process. For example, the system may create a temporary name (e.g., dissolve output). The system may then analyze the subsequent sentence. For this sentence and procedure 2.1, the system may note the two inputs of solution and iodine. The system may therefore determine that the temporary name (e.g., dissolve output) is to be updated to correspond to ‘solution’. For example, the system may note the usage of ‘this’, or similar words (e.g., ‘the’) prior to solution and determine that solution is meant to refer to a prior operation procedure. In FIG. 6C, the system may therefore associate the output of dissolve as being the solution reference in the text of operation procedure 2.1.

In some embodiments, a single process or operation may be preferred for an operation procedure (e.g., a single verb or action). Since the sentence identified above includes two processes (e.g., add, reflux), the system has created two operation procedures. Additionally, the auxiliary group connections may be used for the splitting. For example, FIG. 6B illustrates that a comma and the word ‘and’ are connected to root 602. As another example, reflux 614 is characterized as having a conjunct (e.g., ‘conj’) dependency indicating that it may come after. Thus, the system has included the first process (e.g., add) and the second process (e.g., reflux) on different operation procedure lines.

As illustrated, root node 602 is characterized as a ‘process’ while node 604 is recognized as a material. Nodes 606 and 610 have been recognized as properties. The process knowledge map graphically illustrates this. For example, node 604 is illustrated as being input into process node 602. The properties 606, 610 of node 604 are presented proximate to node 604. These properties may have been included in the information list associated with ‘iodine.’ Additionally, the next process (e.g., reflux) is illustrated below process 602.

With respect to nodes 602 and 604, these nodes may be related according to the relationship information of Tables 4-5. For example, this table includes a parent being a ‘process verb’ with a child being a material associated with tag ‘obj.’ In this example, the system may use the relationship information to determine that node 604 is an input to node 602. The system may also use the relationship to determine that they should be connected via a particular type of connection shown in the Legend (e.g., material flow).

Additionally, a prior sentence may reference a particular node (e.g., node 603). This node indicates use of ‘compound 1’. A prior sentence or sentences may include text to generate compound 1 or which otherwise references compound 1 (e.g., a temperature for compound 1, whether it is to be filtered, and so on). When generating the knowledge map, the system may generate a knowledge map node corresponding to compound 1 when analyzing the prior sentence or prior sentences. Thus, when analyzing the text for operation procedure 1.1, the system may determine that compound 1 corresponds to the previously created knowledge map node. In this way, the system may update the process knowledge map to include nodes above compound 1 (e.g., steps to generate the compound). These nodes may include words from sentences anywhere previously in a textual portion. For example, the textual portion may include initial steps to create compound 1. In this example, the textual portion may then include a significant amount of other text until reaching the text included in procedure 1.1. Since the system has already created a compound 1 knowledge map node, the system may associate the action in procedure 1.1 with the node (e.g., dissolving compound 1 with toluene).

FIG. 6D illustrates example knowledge map(s) which include operation procedure, process, and device configuration nodes. This figure illustrates a more device configurations. As described above with respect to Tables 1-3, nodes may be recognized as entities with a device classification. Thus, information related to devices may be presented as a knowledge map. For example, water source is recognized as a device classification while faucet is recognized as a component device classification. Additionally, the system has linked (e.g., correlated) the device configuration to specific operation procedures (e.g., faucet opens as described in 3.4 and closes as described in 3.9).

In one embodiment, components of constructed knowledge maps are grouped into subsystem knowledge maps to create hierarchy knowledge maps with respect to certain rules. The hierarchy can be multiple levels. For process knowledge maps, the top level can be a single process to convert input materials into output materials.

With respect to grouping, in some embodiments the system described herein may generate a grouping which is associated with a knowledge map. For example, a knowledge map which describes a process by which a particular compound is created may be grouped. In this example, a name may be associated with the grouping such that it may be accessed by a user. When analyzing text which uses the particular compound, the generated knowledge map may include a node related to use of the particular compound. In some embodiments, the user may provide user input to the node via an interactive user interface which is presenting the knowledge map. The interactive user interface may then present the knowledge map associated with creation of the particular compound. For example, the system may determine (e.g., based on the name, metadata, and so on) that the node is associated with its own knowledge map.

In some embodiments, a user may cause grouping of a portion of a knowledge map. For example, the user may name or otherwise title the grouping. A user interface presenting the knowledge map may then be updated to cause the portion to reduce in size and optionally be represented as a node or graphical indicia associated with an underlying knowledge map. In this way, the user may collapse portions of the knowledge map into manageable sizes. Similar to the above, the user may provide input to cause a grouping to expand into a full knowledge map.

In one embodiment, input/output materials are composed of subsystems or components, and the composition knowledge maps are extracted and constructed from the input document according to specific knowledge models. For example, drugs are wrapped in water-soluble polymers for delivery purpose.

In one embodiment, the constructed knowledge maps are compared to the identified models from scanned pictures of the block diagrams in the documents to validate the consistency between the text descriptions and corresponding block diagrams.

### OTHER EMBODIMENTS

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A method implemented by a system of one or more processors, the method comprising:
obtaining a textual portion to be analyzed, the textual portion being associated with process;
accessing a dependency tree associated with the textual portion, the dependency tree being generated via a forward pass through a natural language processing (NLP) model, and the dependency tree organizing the textual portion into nodes connected via connections, wherein individual nodes are associated with individual tokens reflected in the textual portion;
generating one or more knowledge maps based on the dependency tree, wherein the knowledge maps organize the process into individual processes and individual materials, wherein entities are extracted based on the tokens, and wherein relationship information is used to relate the extracted entities to form the knowledge maps; and
causing presentation, via an interactive user interface, of at least a portion of the one or more knowledge maps.

2. (canceled)

3. (canceled)

4. (canceled)

5. The method of claim 1, wherein a first node of the dependency tree is connected to a second node of the dependency tree via a particular type of connection of a plurality of types of connections, wherein the second node is a child node of the first node, wherein the NLP model is trained to assign the particular type of connection, wherein the particular type of connection is a local group connection, and wherein the local group connection describes a contribution by the second node to the expression or property of the first node.

6. (canceled)

7. (canceled)

8. The method of claim 5, wherein an information tree is generated based on the dependency tree, and wherein the information tree removes the second node and includes the token associated with the second node in the first node.

9. The method of claim 8, wherein a subset of the nodes of the information tree have associated information lists, and wherein for each individual node included in the subset the associated information list includes tokens associated child nodes of the individual node which have local group connections in the dependency tree.

10. The method of claim 9, wherein the one or more knowledge maps use the information lists to describe properties of individual processes or materials.

11. The method of claim 5, wherein the particular type of connection is a link group connection, wherein the link group connection describes a relationship between the first node and the second node, and wherein the relationship information uses the link group connections to form the knowledge maps.

12. (canceled)

13. The method of claim 1, wherein the one or more knowledge maps include a first knowledge map which includes individual portions of text included in the textual portion into individual processes, and wherein individual processes include individual actions.

14. The method of claim 13, wherein the interactive user interface presents the first knowledge map, and wherein words included in an individual portion of text are visually adjusted based on whether they are identified as a process, a material, or a property.

15. The method of claim 13, wherein the one or more knowledge maps include a second knowledge map which graphically depicts the individual processes connected to input and output materials.

16. The method of claim 13, wherein the one or more knowledge maps include a third knowledge map which graphically depicts device configuration information associated with the process, and wherein the device configuration information references the first knowledge map.

17. A system comprising one or more processors and non-transitory computer storage media storing instructions that when executed by the one or more processors, cause the one or more processors to perform operations comprising:
obtaining a textual portion to be analyzed, the textual portion being associated with process;
accessing a dependency tree associated with the textual portion, the dependency tree being generated via a forward pass through a natural language processing (NLP) model, and the dependency tree organizing the textual portion into nodes connected via connections, wherein individual nodes are associated with individual tokens reflected in the textual portion;
generating one or more knowledge maps based on the dependency tree, wherein the knowledge maps organize the process into individual processes and individual materials, wherein entities are extracted based on the tokens, and wherein relationship information is used to relate the extracted entities to form the knowledge maps; and
causing presentation, via an interactive user interface, of at least a portion of the one or more knowledge maps.

18. (canceled)

19. (canceled)

20. (canceled)

21. The system of claim 17, wherein a first node of the dependency tree is connected to a second node of the dependency tree via a particular type of connection of a plurality of types of connections, wherein the second node is a child node of the first node, wherein the NLP model is trained to assign the particular type of connection, wherein the particular type of connection is a local group connection, and wherein the local group connection describes a contribution by the second node to the expression or property of the first node.

22. (canceled)

23. (canceled)

24. The system of claim 23, wherein an information tree is generated based on the dependency tree, and wherein the information tree removes the second node and includes the token associated with the second node in the first node.

25. The system of claim 24, wherein a subset of the nodes of the information tree have associated information lists, and wherein for each individual node included in the subset the associated information list includes tokens associated child nodes of the individual node which have local group connections in the dependency tree.

26. The system of claim 25, wherein the one or more knowledge maps use the information lists to describe properties of individual processes or materials.

27. The system of claim 21, wherein the particular type of connection is a link group connection, and wherein the link group connection describes a relationship between the first node and the second node, wherein the relationship information uses the link group connections to form the knowledge maps.

28. (canceled)

29. The system of claim 17, wherein the one or more knowledge maps include a first knowledge map which includes individual portions of text included in the textual portion into individual processes, and wherein individual processes include individual actions.

30. The system of claim 29, wherein the interactive user interface presents the first knowledge map, and wherein words included in an individual portion of text are visually adjusted based on whether they are identified as a process, a material, or a property.

31. The system of claim 29, wherein the one or more knowledge maps include a second knowledge map which graphically depicts the individual processes connected to input and output materials, and wherein the one or more knowledge maps include a third knowledge map which graphically depicts device configuration information associated with the process, and wherein the device configuration information references the first knowledge map.

32. (canceled)

33. Non-transitory computer storage media storing instructions that when executed by a system of one or more processors, cause the one or more processors to perform operations comprising:
obtaining a textual portion to be analyzed, the textual portion being associated with process;
accessing a dependency tree associated with the textual portion, the dependency tree being generated via a forward pass through a natural language processing (NLP) model, and the dependency tree organizing the textual portion into nodes connected via connections, wherein individual nodes are associated with individual tokens reflected in the textual portion;
generating one or more knowledge maps based on the dependency tree, wherein the knowledge maps organize the process into individual processes and individual materials, wherein entities are extracted based on the tokens, and wherein relationship information is used to relate the extracted entities to form the knowledge maps; and
causing presentation, via an interactive user interface, of at least a portion of the one or more knowledge maps.

34.-86. (canceled)
